(19) United States
(12) Patent Application Publication
(10) Pub. No.: US 2007/0178262 A1
(43) Pub. Date: Aug. 2, 2007

(54) Storage wrap material

(75) Inventor: Kenneth Stephen McGuire, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/342,085

(22) Filed: Jan. 27, 2006

(51) Int. Cl. B32B 27/32

(52) U.S. Cl. 428/35.2; 428/173

(57) ABSTRACT

The present invention relates to sheet-like materials suitable for use in the containment and protection of various items. More particularly, the present invention provides an improved storage wrap material comprising a sheet of material having a first side and a second side. The first side comprises an active side exhibiting an adhesion peel force after activation by a user which is greater than an adhesion peel force exhibited prior to activation by a user and exhibiting a wet seal peel force of at least about 20 gf per inch of material.

### FIELD OF THE INVENTION

The present invention relates to sheet-like materials suitable for use in the containment and protection of various items, as well as the preservation of perishable materials such as food items. The present invention further relates to such materials which are suitable for direct contact with such items as a unitary package as well as for use in forming a closure for a semi-enclosed container.

### BACKGROUND OF THE INVENTION

Sheet-like materials for use in the containment and protection of various items, as well as the preservation of perishable materials such as food items, are well known in the art. Such materials can be utilized to wrap items individually and/or can be utilized to form a closure for a semi-enclosed container.

### SUMMARY OF THE INVENTION

The present invention provides an improved storage wrap material comprising a sheet of material having a first side and a second side. The first side comprises an active side exhibiting an adhesion peel force after activation by a user which is greater than an adhesion peel force exhibited prior to activation by a user.

The storage wrap material may be activated by different approaches, but in a preferred embodiment the active side is activatible by an externally applied force exerted upon the sheet of material. The force may be an externally applied compressive force exerted in a direction substantially normal to the sheet of material or may be an externally applied tensile force exerted in a direction substantially parallel to the sheet of material.

The active side of the storage wrap material preferably exhibits an adhesion peel force of at least about 1 ounce per linear inch, more preferably between about 1 and about 2.5 ounces per linear inch, after activation by a user. In accordance with the present invention, the storage wrap material is selectively activatible by a user in discrete regions to provide adhesive properties where and when desired. The use of an adhesive or adhesive-like substance on the surface of the material provides an adhesion peel force after activation which is sufficient to form a barrier seal against a target surface at least as great as those of the material and the target surface such that perishable items, such as food items, may be effectively preserved.

The storage wrap materials of the present invention may be utilized to enclose and protect a wide variety of items by various methods of application, including direct application to the desired item, enclosure of the desired item and sealing to itself, and/or sealing the item in combination with a semi-enclosed container.

Such storage wrap materials of the present invention may be advantageously employed in a container system comprising, in combination, the storage wrap material and a semi-enclosed container with at least one opening surrounded by a peripheral edge. The storage wrap material is adhered to the peripheral edge over the opening following activation by a user to convert the semi-enclosed container to a closed container.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a perspective view of the storage wrap material of the present invention provided in roll form;

FIG. 2 is a plan view of a preferred embodiment of a three-dimensional, nesting-resistant sheet material suitable for use as a storage wrap material in accordance with the present invention;

FIG. 3 is a partial elevational sectional view of the sheet material of FIG. 2, wherein a substance is included within the three-dimensional structure of the web;

FIG. 4 is a plan view of a three-dimensional forming structure suitable for forming a three-dimensional, nesting resistant sheet material such as that of FIG. 3;

FIG. 5 is a partial elevational sectional view of the three-dimensional forming structure of FIG. 4;

FIG. 6 is a schematic illustration of a representative apparatus suitable for forming a storage wrap material in accordance with the present invention;

FIG. 7 is a perspective view of the storage wrap material of the present invention being formed into a unitary package around an item to be stored by bonding the material to itself around the item;

FIG. 8 is a perspective view of the storage wrap material of the present invention being utilized in combination with a semi-enclosed container to form a closed container; and

FIG. 9 is a perspective view of the storage wrap material of the present invention being formed into a unitary package around an item to be stored by bonding overlying portions of the material to itself over the item.

### DETAILED DESCRIPTION OF THE INVENTION

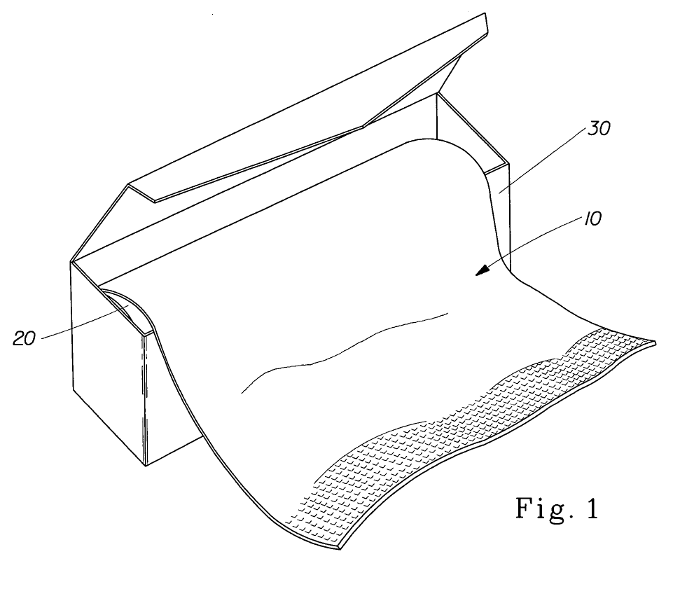

FIG. 1 depicts a preferred embodiment of a storage wrap material 10 according to the present invention. As shown in FIG. 1, storage wrap material 10 is preferably provided in the form of a web of flexible material which can be wound upon a core to form a roll 20 which is suitable for use in a dispenser or holder such as carton 30. If desired, perforations may be provided to facilitate dispensing of pre-measured dimensions of the material in the event that the dispenser, holder, or container does not include a suitable severing apparatus. Manual severing with sharp implements such as knives and scissors may also be accomplished in order to utilize the material in continuous non-perforated form. In alternative storage and dispensing configurations, the storage wrap material may be provided in the form of discrete, pre-measured sheets of uniform or non-uniform dimensions which may be stacked upon one another in any desired sequence and/or orientation and dispensed from a carton, bag, or any other suitable dispensing apparatus. In another alternative storage and dispensing configuration, the storage wrap material may be provided in the form of a continuous web which is Z-folded or pleated and placed in a dispensing carton.

Although storage wrap material may be provided with two active sides or surfaces, if desired for particular applications, in accordance with the present invention it is presently preferred to provide storage wrap material with only one active side and one inactive or inert side.

The active side of the storage wrap material may be selectively activated by a user to provide activated regions where desired to provide selective adhesion of the material to a target surface. The target surface may comprise a separate surface or material, such as a container or an item or items to be wrapped, or may comprise another portion of the storage wrap material itself. Selective activation results in the generation of only so much active area with adhesive properties as is needed, i.e., all remaining portions of the storage wrap material remain inactive or inert. The storage wrap material is therefore capable of forming discrete inactive and active regions on the same side of the material in addition to the ability to have an active side and an inactive side.

Various means of activation are envisioned as being within the scope of the present invention, including, but not limited to compression, extension, and thermal activation. Materials of the present invention exhibit an adhesive, adherent, or tacking character. Accordingly, such materials form a bond or seal when in contact with itself or another target surface. Selectively adherent materials or a pressure-sensitive adhesive may be utilized to provide the desired adhesive properties. The adhesive agent may be selected to provide either a permanent bond or a releasable bond according to the particular application. A permanent bond requires destruction of the storage wrap and/or the container for access to the contents. Releasable bonds provide access to the contents by permitting separation of the wrap from itself or the container at the bond site without destruction. The releasable bond may additionally be refastenable if sufficient adhesive character remains after the initial activation/bonding/release cycle.

The storage wrap material should be sufficiently flexible to conform readily to any desired surface. The memory or resiliency of the material must be sufficiently small that it does not exert undue restorative forces causing the material to break contact with the container/item/target surface and thus becoming prematurely unsecured or unsealed over time. In one embodiment, the material has greater plasticity than elasticity.

The materials of the present invention exhibit an adhesion sufficient to survive the degree of handling the wrapped item or enclosed container is likely to encounter in use while maintaining the desired level of sealing engagement with the item, with itself, or with the accompanying semi-enclosed container such that preservation of perishable items is ensured.

In one embodiment the material of the present invention is substantially clingless. Suitable methods of measuring and quantifying this cling property are described in ASTM test methods D5458-95 and D3354-89. Test method D5458-95 is useful for measuring cling between two layers of film in both stretched and unstretched conditions, and utilizes a 1 inch wide film strip adhered to a flat film attached to an inclined surface. The force required to remove the film strip from the flat film is measured.

Substantially clingless materials in accordance with the present invention can be produced by proper selection of materials including the avoidance of any significant amount of materials known in the art as “cling additives. Further, additional materials or additives can be incorporated as needed to further reduce, if not eliminate, the tendency of such materials to cling to themselves and other surfaces. Such materials would include anti-static agents, etc.

The materials of the present invention comprise standoffs to prevent an adhesive layer from making contact with external surfaces before intended to do so. The standoffs may be deformable, removable, repositionable, or frangible in order to expose the adhesive, when intended, to the target surface. forming one embodiment the material comprise a three-dimensional polymeric film structure with a layer of pressure-sensitive adhesive protected from contact with other surfaces by integrally-formed deformable protrusions or stand-offs. To activate the material, the user exerts a pressure on the desired location of the material to collapse the protrusions and bring the adhesive into engagement with the target surface to form the desired bond. Such materials are described in greater detail in commonly-assigned, U.S. Pat. No. 5,662,758 in the names of Peter W. Hamilton and Kenneth S. McGuire, entitled “Composite Material Releasably Sealable To A Target Surface When Pressed Thereagainst and Method of Making”.

The protrusions may be either compliant or rigid and either planar or non-planar. Inversion of protrusions, especially those made of HDPE, minimizes protrusion spring back so that higher adhesion isn't necessary in order to prevent the failure of relatively weak seals. In one embodiment it is desired that the protrusion remain “dead” or non-resilient after being inverted or crushed. A resilient protrusion could be used with an aggressive and/or permanent adhesive that overcomes spring back. A resilient protrusion may be desirable where repeat use of the material is intended.

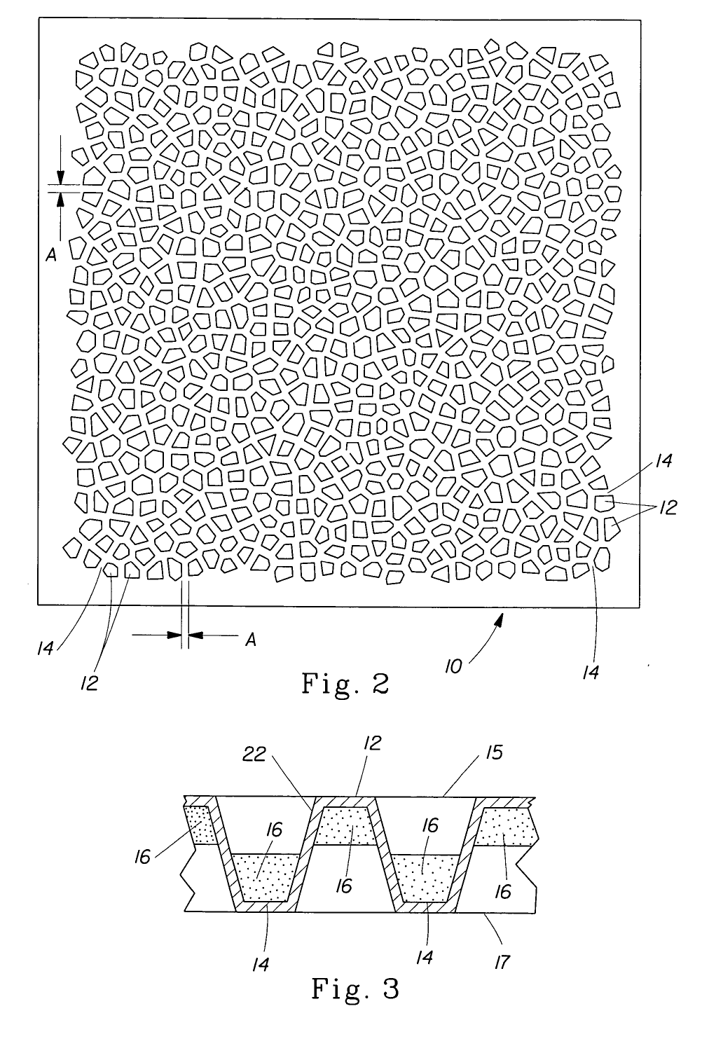

FIGS. 2-3 illustrate a typical storage wrap material 10 constructed in accordance with the aforementioned Hamilton et al. application which is suitable for use as a storage wrap material of the present invention. In one embodiment, the three-dimensional protrusions depicted in FIGS. 2-3 may be formed in an amorphous pattern of two-dimensional geometrical shapes such that the sheet of material resists nesting of superimposed layers such as would be encountered in a roll of product. Such three-dimensional, nesting-resistant materials and patterns are described in greater detail in commonly-assigned, U.S. Pat. No. 5,965,235 granted Oct. 12, 1999 in the names of Kenneth S. McGuire, Richard Tweddell, III and Peter W. Hamilton, entitled “Three-Dimensional, Nesting-Resistant Sheet Materials and Method and Apparatus for Making Same”.

In order to provide the greatest degree of nesting-resistance, the three-dimensional, nesting-resistant sheet materials of the present invention preferably exhibit a two-dimensional pattern of three-dimensional protrusions which is substantially amorphous in nature. As utilized herein, the term “amorphous” refers to a pattern which exhibits no readily perceptible organization, regularity, or orientation of constituent elements. This definition of the term “amorphous” is generally in accordance with the ordinary meaning of the term as evidenced by the corresponding definition in Webster's Ninth New Collegiate Dictionary. In such a pattern, the orientation and arrangement of one element with regard to a neighboring element bear no predictable relationship to that of the next succeeding element(s) beyond.

Manufacturing constraints may require that the amorphous pattern itself be repeated periodically within the web. Although any pattern repetition within the web allows some possibility of nesting occurring, such a possibility only exists when precise alignment of superimposed webs or web portions occurs with such webs or web portions representing exactly one repeat of the pattern (or an integer number of repeats for a continuous wound or folded web).

Three-dimensional sheet materials formed from a material which is initially isotropic within the plane of the material remain generally isotropic with respect to physical web properties in directions within the plane of the material. As utilized herein, the term “isotropic” is utilized to refer to web properties which are exhibited to substantially equal degrees in all directions within the plane of the material. This definition of the term “isotropic” is likewise generally in accordance with the ordinary meaning of the term as evidenced by the corresponding definition in Webster's Ninth New Collegiate Dictionary. By way of example, such a sheet of material could exhibit substantially uniform tensile properties in any direction within the plane of the material if the starting material was isotropic in tensile properties.

Within the amorphous pattern, protrusions may be non-uniform with regard to their size, shape, orientation with respect to the web, and spacing between adjacent protrusion centers.

A sheet or web of material may be intentionally created with a plurality of amorphous areas within the same sheet or web, even to the point of replication of the same amorphous pattern in two or more such regions. The designer may purposely separate amorphous regions with a regular defined, non-amorphous pattern or array, or even a “blank” region with no protrusions at all, or any combination thereof. The formations contained within a non-amorphous area can be of any number density, height or shape. Further, the shape and dimensions of the non-amorphous region itself can be customized as desired. Examples of formation shapes include but are not limited to: wedges emanating from a point; truncated wedges; polygons; circles; curvilinear shapes; and combinations thereof.

A single amorphous region may fully envelop or circumscribe one or more non-amorphous areas. As an example a single continuous amorphous region may fully enclose a non-amorphous pattern near the center of the sheet or web. Such imbedded patterns may communicate brand name, the manufacturer, instructions, material side or face indication, other information or simply be decorative in nature.

Multiple non-amorphous regions may be abutted or overlapped in a substantially contiguous manner to substantially divide one amorphous pattern into multiple regions or to separate multiple amorphous regions that were never part of a greater single amorphous region beforehand.

Webs according to the present invention may have protrusions formed of virtually any three-dimensional shape, and accordingly need not be all of a convex polygonal shape. forming one embodiment the protrusions may be formed in the shape of substantially-equal-height frustums having convex polygonal bases in the plane of one surface of the material having interlocking, adjacent parallel sidewalls.

As used herein, the term “polygon” (and the adjective form “polygonal”) is utilized to refer to a two-dimensional geometrical figure with three or more sides, since a polygon with one or two sides would define a line. Accordingly, triangles, quadrilaterals, pentagons, hexagons, etc. are included within the term “polygon”, as would curvilinear shapes such as circles, ellipses, etc. which would have an infinite number of sides.

Referring once again to FIG. 2, there is shown a plan view of a representative three-dimensional, nesting-resistant sheet material suitable for use as a storage wrap material of the present invention, which is generally indicated as 10. Material 10 has a plurality of non-uniformly shaped and sized, preferably hollow, protrusions 12, surrounded by spaces or valleys 14 therebetween, which are preferably interconnected to form a continuous network of spaces within the amorphous pattern. FIG. 2 also shows a dimension A, which represents the width of spaces 14, measured as the substantially perpendicular distance between adjacent, substantially parallel walls at the base of the protrusions. In a preferred embodiment, the width of spaces 14 is preferably substantially constant throughout the pattern of protrusions.

Protrusions 14 are preferably spaced center to center an average distance of approximately two protrusion base diameters or closer, in order to minimize the volume of valleys between protrusions and hence the amount of substance located between them. For applications where it is intended that the protrusions be deformable, the protrusions 14 preferably have heights which are less than their diameters, so that when they deform, they deform by substantially inverting and/or crushing along an axis which is substantially perpendicular to a plane of the material. This protrusion shape and mode of deforming discourages protrusions 14 from folding over in a direction parallel to a plane of the material so that the protrusions cannot block a substance present in the valley between them from contact with a target surface.

In one embodiment, protrusions 14 have an average base diameter of about 0.015 inches (0.038 cm) to about 0.030 inches (0.076 cm), and more preferably about 0.025 inches (0.064 cm). They also have an average center-to-center spacing of from 0.03 inches (0.08 cm) to 0.06 inches (0.15 cm), and more preferably about 0.05 inches (0.13 cm) spacing. This results in a high number density of protrusions. The more protrusions per unit area, the thinner the piece of material and protrusion walls can be in order to resist a given deformation force. In a preferred embodiment the number of protrusions per square inch exceeds 200 and the protrusions occupy from about 30% to about 70% of the protrusion side of the piece of material. They have a protrusion height of about 0.004 inches (0.010 cm) to 0.012 inches (0.030 cm), and more preferably about 0.006 inches (0.015 cm) height. The preferred material is 0.0003 inch (0.0076 mm) nominal thickness high density polyethylene (HDPE).

FIG. 3 depicts a fragmentary elevational cross-section of material 10 taken at a location where a complete protrusion 12 and both adjoining spaces or valleys 14 can be seen in cross-section. In this view, the upper surface of the web which faces the viewer of FIG. 2, and which includes the projecting portions of the protrusions 12, is identified with the numeral 15, and is referred to hereafter as the male side of the material. Correspondingly, the lower surface of the web facing away from the viewer of FIG. 2, which includes the openings of the hollow portions of the protrusion 12, is identified with the numeral 17, and is referred to hereafter as the female side of the material.

FIG. 3 shows a substance 16 added to spaces 14, as well as to the hollow underside of the protrusion 12, in accordance with the teachings of U.S. Pat. No. 5,871,607, entitled “Material Having A Substance Protected by Deformable Standoffs and Method of Making”, Substance 16 partially fills the spaces 14 so that an outer surface of protrusions 12 remain external to the surface level of substances 16 such that the protrusions prevent the substances 16 on the male side of the material from making contact with external surfaces. With regard to the male side of the material, substances 16 partially fills the hollow protrusions such that the reverse side of the valleys or spaces between respective protrusions serves an analogous function in preventing substances 16 within the protrusions from making contact with external surfaces. Substances within different sides of the material 10 and/or within different geometrically-distinct zones within a side of material 10 need not be the same substance and could in fact be distinctly different substances serving distinctly different functions.

“Substance” is defined in this invention as any material capable of being held in open valleys and/or depressions of a three dimensional structure. In the present invention, the term “substance” can mean a flowable substance which is substantially non-flowing prior to delivery to a target surface. “Substance” can also mean a material which doesn't flow at all, such as a fibrous or other interlocking material. “Substance” may mean a fluid or a solid. Adhesives, electrostatics, mechanical interlocking, capillary attraction, surface adsorption, and friction, for example, may be used to hold the substances in the valleys and/or depressions. The substances may be permanently held in the valleys and/or depressions, or the substances may be intended to be released therefrom when exposed to contact with external surfaces or when the three dimensional structure is deformed, heated, or otherwise activated. Of current interest in the present invention include substances such as gels, pastes, foams, powders, agglomerated particles, prills, microencapsulated liquids, waxes, suspensions, liquids, and combinations thereof.

The spaces in the three-dimensional structure of the present invention are normally open; therefore it is desirable to have substances stay in place and not run out of the structure without an activation step. The activation step of the present invention is preferably deformation of the three-dimensional structure by compression. However, an activation step to cause substance to flow could be heating the material to above room temperature or cooling it below room temperature. Or it could include providing forces excessive of the earth's gravity. It could also include other deforming forces, such as tensile forces and combinations of these activation phenomena.

The term “deformable material” is intended to include foils, polymer sheets, cloth, wovens or nonwovens, paper, cellulose fiber sheets, co-extrusions, laminates, and combinations thereof. The properties of a selected deformable material can include, though are not restricted to, combinations or degrees of being: porous, non-porous, microporous, gas or liquid permeable, non-permeable, hydrophilic, hydrophobic, hydroscopic, oleophilic, oleophobic, high critical surface tension, low critical surface tension, surface pre-textured, elastically yieldable, plastically yieldable, electrically conductive, and electrically non-conductive. Exemplary materials include wood, metal, rigid polymer stock, ceramic, glass, cured resin, thermoset materials, cross-linked materials, rubber, frozen liquids, concrete, cement, stone, man-made materials, etc. Such materials can be homogeneous or composition combinations.

In one embodiment of an adhesive-containing, three-dimensional, nesting-resistant sheet material, substance 16 comprises a layer of a latex pressure sensitive adhesive about 0.001 inch (0.025 mm) thick. In another embodiment substances 16 comprises a layer of hot melt adhesive, specification no. Fuller HL-2115X made by H. B. Fuller Co. of Vadnais Heights, Minn., from about 0.0005 inch (0.013 mm) to about 0.002 inch (0.051 mm) thick. In another embodiment, substance 16 comprises a layer of National Starch 3A-176A hot melt adhesive, available from the National Starch and Chemical company of Independence, Ky., from about 0.0005 inch (0.013 mm) to about 0.002 inch (0.051 mm) thick. Any adhesive can be used which suits the needs of the material application. Adhesives may be refastenable, releasable, permanent, or otherwise. The size and spacing of protrusions is preferably selected to provide a continuous adhesive path surrounding protrusions so that air-tight seals may be made with a target surface.

The selected adhesive may provide the material with a wet seal adhesion peel force after activation of at least about 20 gf per inch of material. Alternatively, the wet seal adhesion peel force may be at least about 40 gf per inch. In another alternative, the wet seal adhesion peel force may be at least about 60 gf per inch. In still another alternative the wet seal adhesion peel force may be at least about 80 gf per inch.

Wet seal adhesion peel force is defined as the adhesion of a material to a surface wetted with water. Wet seal adhesion peel force is determined by the wet peel test set forth below. The National Starch 34-176A adhesive provided the material a wet peel adhesive of 100 gf per inch when tested. The adhesive may additionally provide a significant seal peel even after the seal has aged. The 34-176A adhesive provides a seal peel of at least about 80 gf per inch after the seal has been aged for 24 hours at 120 degrees Fahrenheit. Seal peel refers to the force requires to peel a portion of the material from a seal formed between two portions of the adhesive side of the material sealed together.

Wet Peel Test Procedure:

Three strips of material, each one inch in width are cut from a sheet of the material. An adhesive label is affixed to one end of each strip. The strips are stored with the adhesive side facing up and out of contact with any release liner.

A clean dry stainless steel plate, two inches by eight inches (5 by 20 cm) is weighed and the tare of the balance is set to the weight of the plate. Water is sprayed onto the plate and the plate is weighted again. The weight of the added water should be between 0.023 and 0.027 grams.

A clean glass plate, two inches by eight inches, (5 by 20 cm) should be used for the test. Water should be applied to the glass plate as it was applied to the steel plate. After the water is applied a strip of material should be placed upon the glass plate with the adhesive side facing the water. The strip should be smoothed and then rolled down using a Cheminstruments, RD3000, available from Cheminstruments Inc., of Fairfield, Ohio, applying ten pounds of force (44 N) to the strip at 24 inches (61 cm) per minute rolling the strip once in each direction along the length of the strip. The 90 degree peel test using the MTS tensile tester model 1G, available from MTS System Corp., of Eden Prairie, Minn., performing the Peel04 test at a test speed of 12 inches (30.5 cm) per minute with a test length of 5 inches (12.5 cm) and a gage length of 3 inches (7.5 cm), should then be performed within 30 seconds of the roll down of the strip.

Film materials may be made from homogeneous resins or blends thereof. Single or multiple layers within the film structure are contemplated, whether co-extruded, extrusion-coated, laminated or combined by other known means. The key attribute of the film material is that it be formable to produce protrusions and valleys. Useful resins include polyethylene, polypropylene, PET, PVC, PVDC, latex structures, nylon, etc. Polyolefins are generally preferred due to their lower cost and ease of forming. Preferred material gauges are about 0.0001 inches (0.0025 mm) to about 0.010 inches (0.25 mm). More preferred gauges are from about 0.0002 inches (0.005 mm) to about 0.002 inches (0.051 mm). Even more preferred gauges are from about 0.0003 inches (0.0076 mm) to about 0.001 inches (0.025 mm).

For some applications it is desirable to provide a stiffness (deformation resistance) which is sufficient to withstand a pressure of at least 0.1 pounds per square inch (0.69 kPa) without substantially deforming protrusions to where the substance contacts an external surface. An example of this requirement would be the need to wind the web onto a roll for transport and/or dispensing. Even with very low in-wound pressures of 0.1 pounds per square inch (0.69 kPa), a residual in-wound pressure in the interior of the roll may deform protrusions in the web sufficiently to bring the overlaying web layers into contact with the substance. A “threshold” protrusion stiffness is required to prevent this winding damage from occurring. Similarly, when the web is stored or dispensed as discrete sheets, this “threshold” stiffness is required to prevent premature activation of the product due to the weight of overlaying layers of sheets or other forces, such as forces induced by shipping vibrations, mishandling, dropping and the like.

Protrusions 12 have sidewalls 22, which become thinned when protrusions 12 are formed, to help ensure that protrusions 12 deform as intended. In one embodiment protrusions 12 have a convex polygonal base shape. By convex polygonal shape, it is meant that the bases of the protrusions have multiple (three or more) linear sides, which form no externally measured angle of less than 180 degrees with any adjacent side. Alternative base shapes may be used. Polygons may interlock in the plane of the lower or female surface 17, as in a tessellation, to provide constant width spacing between them. The width A of spaces 14 may be selected depending upon the volume of substance desired between protrusions. In one embodiment, width A is always less than the minimum protrusion dimension of any of plurality of protrusions 12. In one embodiment the area occupied by plurality of protrusions 12 is from about 30% to about 70%. In another embodiment the area occupied by plurality of protrusions 12 is about 50%, of the available area of sheet of material 10, as measured parallel to plane 20.

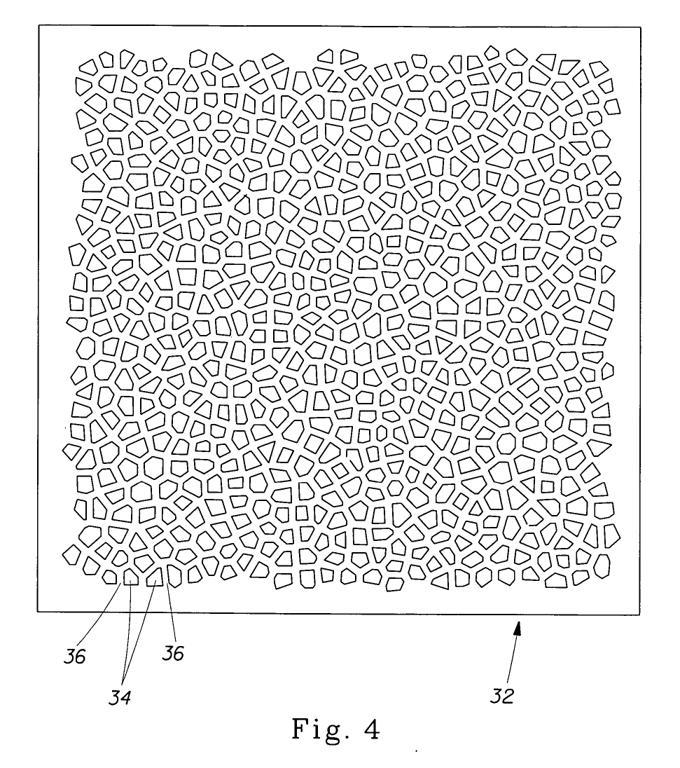

FIGS. 4-6 disclose a suitable method and apparatus for making material 10, the method generally indicated as 30. Method 30 is representative and may be modified or tailored to suit a particular size, composition, etc. of the resulting material 10. In one embodiment method 30 utilizes a forming surface 32, a three-dimensional screen having recesses 34 and lands 36 between recesses 34. Such a forming structure or forming structure would constitute a female-type forming structure which, in use, would form corresponding male protrusions in the structure-contacting side of the formed material. Alternatively, forming surface 32 could comprise a three-dimensional forming structure of the male variety by having raised pins 34 of the desired polygonal shape having recesses 36 between and around the pins 34. In use, such a forming structure would form corresponding female depressions in the structure-contacting side of the formed material.

FIG. 4 depicts a forming surface which could be utilized to form a corresponding three-dimensional material 10 such as depicted in FIG. 2. When a material 10 is thermoformed over forming surface 32, protrusions 12 may be formed by drawing them into recesses 34 with vacuum when material 10 is heated to a softening temperature, and then maintaining protrusions 12 drawn into recesses 34 while material 10 cools to a solidification temperature. In this method, lands 36 define the bases of spaces 14 between protrusions 12. Protrusions 12 may be formed with sidewalls 22 being as nearly perpendicular to plane 20 as possible, but with some taper being typical. Outermost ends of protrusions 12 may be domed or more truncated in shape so as to form frustums of the corresponding polygonal shape.

Material 10 may be vacuum thermoformed, embossed, or hydroformed, or formed by other forming means commonly known in the art for permanently deforming thin materials.

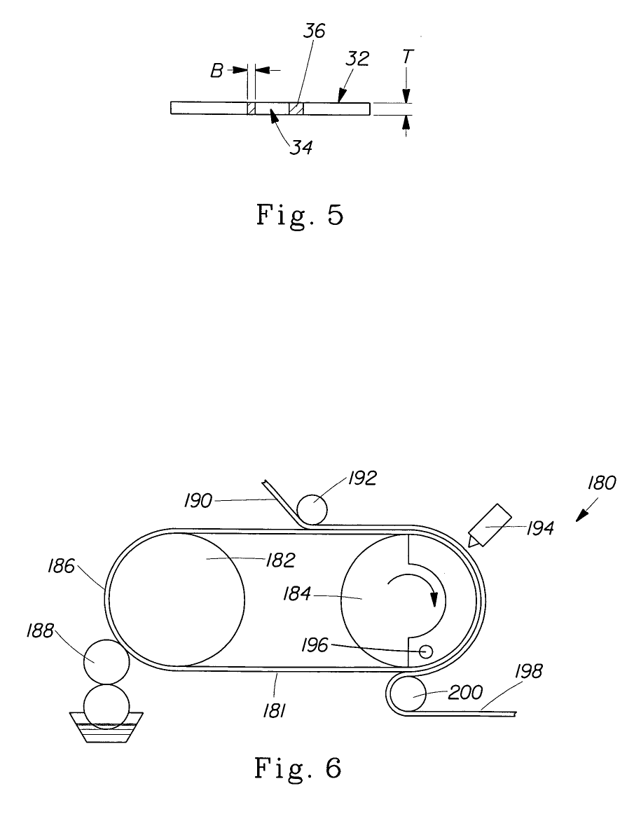

Lands 36 may be made of stainless steel and coated with a release agent. In one embodiment, screen 32 may be made into a continuous belt 38, as shown in FIG. 6. Alternatively, screen 32 could be utilized in flat plate-like form or formed into a rigid drum. FIG. 5 depicts a partial cross-sectional view of forming screen 32 taken at a location which depicts a cross-section through two consecutive lands. Lands 36 have a dimension B which represents the land width, which is preferably constant as measured between substantially parallel adjacent land edges, and a dimension T which represents screen thickness.

The use of a forming screen with essentially straight screen walls which define the forming screen hole may enable a substantially thinner sidewall thickness since the protrusion is freely drawn from the base perimeter into the forming screen recess to the point of contact with the internal backup screen. The internal backup screen's purpose is to prevent further drawing of the protrusion. This approach may yield a more varied gauge profile within the sidewalls.

FIG. 6 shows a suitable method and apparatus for making a material such as material 10 of the present invention, which is generally indicated as 180. The formed material may be transparent or translucent, so that it may be accurately positioned before being deformed. Transparency, however, introduces a new problem of determining on which side of the three-dimensional structure the substance is located, in order to know which side to place against a target surface. Exemplary substance side identification solutions include placing indicia on the surface of the three dimensional structure, coloring the substance a different tint than the three dimensional structure, or providing a laminated material structure of different tints. In a label embodiment material edges may be used for proper positioning.

Micro-texturing the material during forming may also be useful, such as in producing a distinction between one side of the material and the other side. Micro-texturing for example, by drawing the piece of material into forming screen recesses and against a micro-textured surface, such as a vacuum drum having tiny apertures therein.

Forming screen 181 is threaded over idler pulley 182 and a driven vacuum roll 184. Forming screen 181 is preferably a 0.005 inch (0.013 cm) thick, 12.5 inch (31.8 cm) wide, 6 foot (183 cm) circumference stainless steel belt, having the desired protrusion pattern etched as recesses in the belt. Covering the outer surface of vacuum roll 184 is a 195 mesh seamless nickel screen having a diameter of 8.63 inches (21.9 cm), which serves as a porous backing surface for forming screen 181.

For producing a pressure sensitive adhesive containing material, a substance 186, preferably hot melt adhesive, is coated onto forming screen 181 by a substance applicator 188 while forming screen 181 travels at about 20 feet (610 cm) per minute. A material 190, for example, a HDPE film web about 0.0005 inches (0.0013 cm) thick, is brought into contact with the substance-coated forming screen at material infeed idler roll 192. Hot air at approximately 600.degree. F. (316.degree. C.) and flowing at approximately 11.25 SCFM (0.32 cubic meters/minute) is directed radially at material 190 by a hot air source 194 as the material passes over vacuum roll 184 and as vacuum is applied to forming screen 181 through vacuum roll 184 via fixed vacuum manifold 196 from a vacuum source (not shown). A vacuum of approximately 12 inches of mercury (40.6 kPa) is applied as the material is heated by hot air source 194. A formed, substance coated material 198 is stripped from forming screen 181 at stripping roll 200.

Stainless steel forming screen 181 is a fabricated, seamed belt. It is fabricated in several steps. The recess pattern is preferably developed by a computer program according to the method described above and is preferably printed onto a transparency to provide a photomask for photoetching. The photomask is used to create etched and non-etched areas. The etched material is typically stainless steel, but it may also be brass, aluminum, copper, magnesium, and other materials including alloys. Methods of making metal screens by photoetching are described in more detail in U.S. Pat. No. 4,342,314 to Radel and Thompson, U.S. Pat. No. 4,508,256 to Radel et al., and U.S. Pat. No. 4,509,908 to Mullane, Jr.

Additionally, the recess pattern may be etched into photosensitive polymers instead of metals. Examples are described along with a methods of making polymer forming screens in commonly owned U.S. Pat. No. 4,514,345 to Johnson et al., U.S. Pat. No. 5,098,522 to Smurkoski et al., U.S. Pat. No. 4,528,239 to Trokhan, and 5,245,025 to Trokhan.

Next, the forming screen is converted into a continuous belt by butt welding the ends together, using either laser or electron beam welding. This produces a nearly undetectable seam, which is needed to minimize disruptions in the recess pattern. The final step is coating the endless belt with a low critical surface tension (non-stick) coating, such as a Series 21000 proprietary release coating made by and applied by Plasma Coatings of TN, Inc., located in Memphis, Tenn. As applied to a stainless steel forming screen used in the methods of the present invention, this coating provides a critical surface tension of about 18 dynes/cm. Other materials which may prove suitable for providing reduced critical surface tension include paraffins, silicones, PTFE's, and the like. This coating allows the formed material to be removed from the belt without undue stretching or tearing.

A belt forming screen is believed advantageous to a flat plate or a drum forming screen because a belt enables screen patterns and pattern lengths to be changed more easily and larger patterns may be used without having massive rotating members. However, depending upon the desired quantity and dimensions of the material 10 to be formed it may be equally suitable to fabricate the forming structure as a flat plate or rigid drum, and/or other forming structures and methods known in the art.

Because the same common forming screen is used to transfer the substance to the material as is used to form the protrusions, the substance pattern is conveniently registered with the protrusions. In the preferred embodiment, the top surface of forming screen 32 is continuous except for recesses 34; thus, the substance pattern is totally interconnected in this configuration. However, if a discontinuous pattern of substance were coated onto forming screen 32, a discontinuous substance pattern between protrusions would result.

In accordance with the preferred method of manufacturing the three-dimensional, nesting-resistant sheet material 10, the three-dimensional protrusions are unitarily formed from the sheet of deformable material itself and are hollow structures with depressions in one side which preferably each have a size and three-dimensional shape corresponding substantially with the size and three-dimensional shape of their respective protrusion. However, it may also be desirable for some applications to utilize solid protrusions unitarily, integrally, or separately formed from (and applied to) the sheet of material and which may or may not be deformable.

In general, the present invention is a storage wrap material which may take the form of a three-dimensional sheet material which is activated by applying a compressive force so that the structure collapses to expose an adhesive to contact with external surface(s). However, the scope of the invention also applies to storage wrap materials which are activatible by means other than compression. For example, the inventors have found that a tensile force applied to the same three-dimensional structure can cause it to plastically deform longitudinally and thereby contract in caliper or thickness to similarly expose or release substance. It is believed that under sufficient tension, the material between protrusions deforms in response to forces in the plane of the material and that protrusions are thereby elongated in the same direction. When the protrusions are elongated, they are reduced in height. With enough elongation the protrusions are reduced in height to where the substances between them, in them, or both are exposed.

For a one inch wide strip of material 10, made from 0.0003 inch (0.0076 mm) thick HDPE and formed to have protrusions of 0.006 inches (0.152 mm) height and 0.030 inches (0.762 mm) diameter, spaced 0.045 inches (1.14 mm) apart, the tensile force found necessary to cause protrusions to expose a 0.001 inch (0.025 mm) thick coating of adhesive in the valleys between protrusions is approximately 0.80 pounds (0.36 kg) per inch of strip width.

A combination of compression and tensile forces may be applied to the material of the present invention in order to expose a substance from within the three-dimensional structure. Although in a preferred embodiment of the present invention, the tensile force necessary to achieve sufficient deformation of said three-dimensional structure in order to expose substance to an external surface is significantly greater than a compressive force to achieve the same result, a structure may be designed which is more easily deformed by a tensile force applied in a specific planar direction. For example, a structure may have parallel waves instead of protrusions and the waves may be easily flattened by stretching the structure perpendicular to the waves but in the plane of the waves. Tensile responsive structures and the principles behind them are disclosed in commonly-assigned U.S. Pat. No. 5,518,801 to Chappell et al.

In another example, heat could be applied to cause the same structure made of shrinkable film to reduce in thickness to similarly release or expose the substance.

As described herein, different substances can be deposited on the opposing faces of the formed material. Multiple substances can be located on the same face of the material either geometrically spaced from each other or commingled. Substances can be partially layered. An example is a layer of adhesive adjacent to the material surface with a solid particulate adhered to the exposed side of the adhesive layer. In addition, it is contemplated that it may be desirable for certain applications to have protrusions extending outwardly from both sides of the formed material, such that both sides are active sides with deformable protrusions.

A pattern of protrusions can be superimposed either on a similar dimensional scale or on a different dimensional scale such as a single or multiple “microprotrusion” pattern located on the tops of other larger protrusions.

Additional details of the process of FIG. 6, as well as additional details regarding three-dimensional materials described above may be found in the aforementioned U.S. Pat. No. 5,871,607.

While under some circumstances it may be acceptable or desirable to design the storage wrap material so as to form a discontinuous bond pattern with itself or another target surface, such as by having an intermittent or discontinuous layer of adhesive on its active surface, it is presently preferred that the storage wrap material be designed so as to exhibit the ability to form a continuous seal or bond with itself and with any sufficiently continuous target surface.

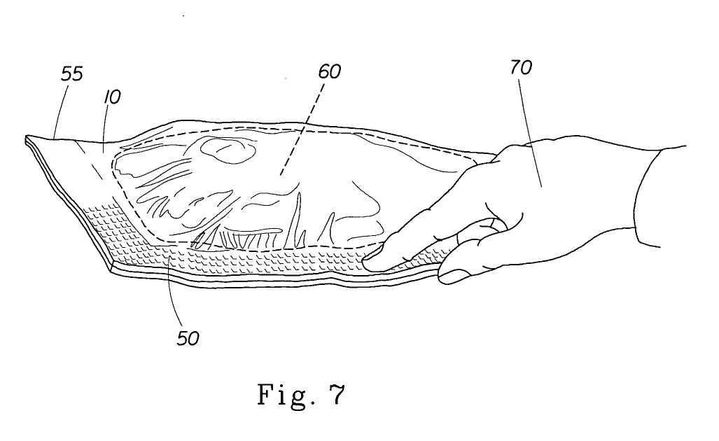

FIGS. 7-9 depict representative applications of interest for the storage wrap material 10. More particularly, FIG. 7 depicts storage wrap material 10 utilized independently to form a closed container for an item 60. For use in this fashion, a one-sided version of storage wrap material 10 is preferably utilized such that only one side of the material is active, although a two-sided material could also be utilized. To utilize storage wrap material 10 in this fashion, the material is wrapped or folded around the desired item 60 so as to leave a marginal edge extending outwardly beyond the maximum dimensions of the item 60. As depicted in FIG. 7, the web of storage wrap material 10 has been folded over and around the item 60 by folding the material along a folded edge 55 and forming a fin-type seal 50 around the remaining perimeter, in this instance three sides, of the item 60. In this deployment, the storage wrap material 10 is bonded or adhered to itself in a face-to-face orientation wherein both active sides of the material are in contact with one another. Accordingly, when a user 70 activates the adhesive on at least one, and preferably both, of the overlying or overlapping portions of the material in the region of the fin seal 50 the overlying portions are firmly adhered together to complete the enclosure of the item 60. Alternatively, rather than folding a larger web of material upon itself to form an enclosure, two or more discrete smaller pieces of storage wrap material 10 may be utilized by wrapping them over the item 60 and sealing them to one another in face-to-face or face-to-back orientation.

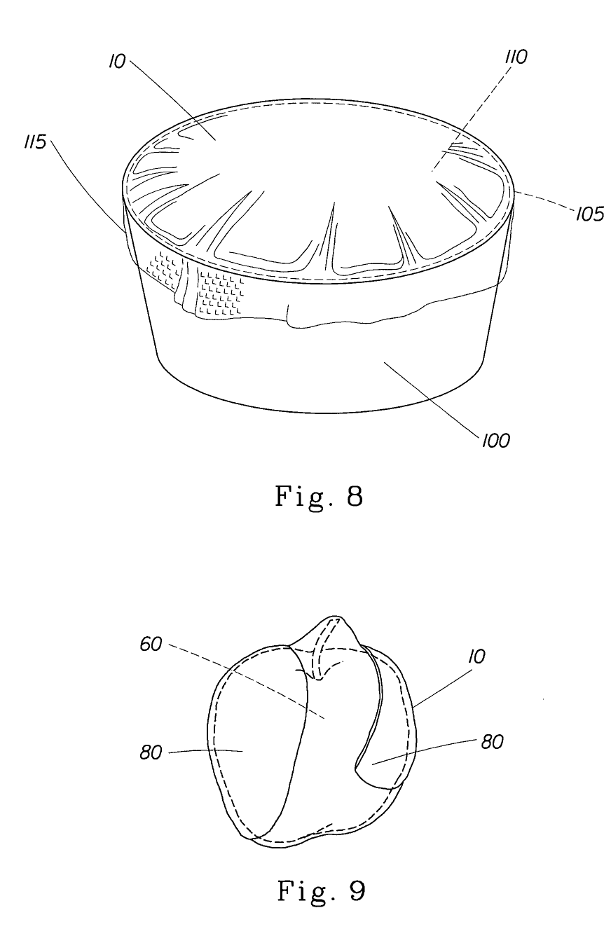

FIG. 8 depicts another useful deployment of storage wrap material 10 as the closure of a semi-enclosed, rigid or semi-rigid container 100. In the configuration of FIG. 8, a combination container structure is thus illustrated wherein the storage wrap material is adhered to the rim portion 105 of the container which circumscribes the opening 110 to form a corresponding closure for the opening. The storage wrap material 10 may also be applied so as to effect a seal over an additional area around the periphery of the rim 105 by bonding to the wall portion 115 of the container which extends in a direction substantially normal to the plane of the opening. Effective sealing may also be accomplished by bonding the storage wrap material only to the wall portion 115 of the container. Where such a closure completely encloses the contents (not shown) of the container 100, the contents are protected from the exterior environment outside the container and are also contained and protected from loss.

Containers such as container 100, which as shown has no protruding structures for cooperating with storage wrap 10, are frequently constructed of such rigid or semi-rigid materials such as metals, glass, ceramics, plastics, or wood which have a comparatively smooth and uniform surface. Accordingly, storage wrap material 10 in accordance with the present invention activates to provide the desired level of adhesive force in combination with such non-conforming, rigid or semi-rigid surfaces so as to effectively form a closure for such containers. In addition, the storage wrap material may also be utilized in conjunction with openings in the plane of a wall of a container as well as openings which are formed at an end, etc. of a container substantially normal to adjacent wall surfaces. Such versatility is due to the adhesive properties of the storage wrap material which, unlike dead-fold wrap materials such as waxed paper or aluminum foil, enable the storage wrap materials of the present invention to form a suitable seal without the need to form a wrap angle around a rim, lip, or other structure adjacent the container opening.

FIG. 9 depicts yet another application for storage wrap 10, wherein a discrete web of storage wrap 10 of the desired dimensions is wrapped continuously around an item 60 so as to enclose the item 60 completely. Edge portions 80 of the storage wrap 10 which overly the item and overly other portions of the storage wrap 10 are adhered to such other portions after activation such that they are secured in sealing relationship. This mode of item enclosure is particularly useful when the item has an irregular shape, such as the item 60 depicted in FIG. 9. In this mode of deployment, the storage wrap 10 is preferably oriented with the active side facing inwardly toward the item 60 such that the storage wrap may be activated over the item to provide additional security against shifting or loosening of the material. Alternatively, the storage wrap 10 could be wrapped around the item with the active side facing outwardly if adherence to the item is not desired. In either mode of deployment, the overlying portions 80 of the storage wrap material 10 will be activated and adhered to one another in face-to-back relation with one of the overlying portions being activated to provide the adhesive property and the other overlying portion being non-activated and hence a passive target surface.

If a two-sided activatible storage wrap material were utilized in the above example, then either or both of the superimposed face and back portions in the overlying portions 80 could be activated to effect a sealed region.

The improved storage wrap materials of the present invention may be employed to enclose a wide variety of items, both perishable and non-perishable. Such items may include single items within a given container/package system, as well as multiple items of the same or different types. Items enclosed may in fact be containers or packages which are themselves to be enclosed, such as a group of cartons wrapped together upon a pallet, for example. The items may be loosely grouped together within a single chamber within the container, or may be segregated within different chambers or compartments formed by the storage wrap material itself or other features of the container.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An improved storage wrap material comprising:
(a) a sheet of non-porous material having a first side and a second side, said first side comprising an active side exhibiting an adhesion peel force after activation by a user which is greater than an adhesion peel force exhibited prior to activation by a user and which is sufficient to form a continuous seal against any target surface, wherein said active side exhibits an wet seal adhesion peel force of at least about 20 gf per inch width after activation by a user.

2. The improved storage wrap material of claim 1, wherein said active side is activatible by an externally applied force exerted upon said sheet of material.

3. The improved storage wrap material of claim 2, wherein said active side is activatible by an externally applied compressive force exerted in a direction substantially normal to said sheet of material.

4. The improved storage wrap material of claim 2, wherein said active side is activatible by an externally applied tensile force exerted in a direction substantially parallel to said sheet of material.

5. The improved storage wrap material of claim 1, wherein said active side exhibits a wet seal adhesion peel force of at least about 40 gf per inch width after activation by a user.

6. The improved storage wrap material of claim 1, wherein said active side exhibits a wet seal adhesion peel force of at least about 60 and about 300 gf per inch width after activation by a user.

7. The improved storage wrap material of claim 1, wherein said active side may be selectively activated in discrete regions by a user.

8. The improved storage wrap material of claim 1, wherein said active side exhibits a wet seal adhesion peel force of at least about 80 gf per inch width after activation by a user.

9. The improved storage wrap material of claim 1, wherein said adhesion peel force after activation is sufficient to form a barrier seal against a target surface, said seal exhibiting barrier properties at least as great as those of said material and said target surface.

10. The improved storage wrap material of claim 1, wherein both said first side and said second side comprise active sides of said material.

11. The improved storage wrap material of claim 1, wherein said sheet of material comprises a polymeric film material.

12. The improved storage wrap material of claim 1, wherein said active side comprises a plurality of three-dimensional non-adherent protrusions extending outwardly from said sheet of material and a pressure-sensitive adhesive surrounding said non-adherent protrusions, said adhesive having a thickness less than the height of said non-adherent protrusions before activation.

13. The improved storage wrap material of claim 12, wherein said second side includes a plurality of spaced, three-dimensional hollow depressions corresponding to said protrusions, such that said protrusions are hollow, and wherein said depressions are partially filled with a pressure-sensitive adhesive.

14. The improved storage wrap material of claim 12, wherein said protrusions are unitarily formed from said sheet of material.

15. The improved storage wrap material of claim 1, wherein said sheet of material is clingless and exhibits no adhesion peel force prior to activation by a user.

16. The improved storage wrap material of claim 1, further comprising a dispenser, said sheet of material forming a continuous web wound to form a roll of storage wrap material, said roll of storage wrap material being disposed within said dispenser.

17. The improved storage wrap material of claim 16, further comprising a core disposed within said dispenser, said sheet of material being wound upon said core to form said roll of storage wrap material.

18. The improved storage wrap material of claim 16, wherein said dispenser includes a severing apparatus.

19. An improved storage wrap material comprising:
(a) a sheet of non-porous substantially translucent polymeric film material having a first side and a second side, said first side comprising an active side which is activatible by an externally applied compressive force exerted in a direction substantially normal to said sheet of material, said active side exhibiting an adhesion peel force after activation by a user which is greater than an adhesion peel force exhibited prior to activation by a user and wherein said active side exhibits a wet seal adhesion peel force of at least about 60 and about 300 gf per inch width after activation by a user, wherein said active side comprises a plurality of three-dimensional non-adherent protrusions unitarily formed from and extending outwardly from said sheet of material and a pressure-sensitive adhesive surrounding said non-adherent protrusions, said adhesive having a thickness less than the height of said non-adherent protrusions before activation.

20. An improved storage wrap material comprising:
(a) a sheet of non-porous material having a first side and a second side, said first side comprising an active side exhibiting an adhesion peel force after activation by a user which is greater than an adhesion peel force exhibited prior to activation by a user and which is sufficient to form a continuous seal against any target surface, wherein said active side exhibits an aged seal adhesion peel force of at least about 20 gf per inch width after activation by a user.
